(19) United States
(12) Patent Application Publication
(10) Pub. No.: US 2003/0174963 A1
(43) Pub. Date: Sep. 18, 2003

(54) Strain optimized cantilever pigtail attach method with low moment staking

(76) Inventors: Gordon C. Brown, Worcester, MA (US); Chuck J. Mullen JR., Billerica, MA (US); Stanley R. Shanfield, Newton, MA (US)

Correspondence Address: Attn: Matthew E. Connors, Samuels, Gauthier & Stevens, LLP, Suite 3300, 225 Franklin Street, Boston, MA, 02110, US

(21) Appl. No.: 10/098,208

(22) Filed: Mar. 14, 2002

(51) Int. Cl. G02B 6/30; G02B 6/26

(52) U.S. Cl. 385/49; 385/50; 385/88

(57) ABSTRACT

A pigtail attach system that exhibits little degradation or change in the coupling during curing and minimizes the impact of different thermal expansion coefficients between the fiber and the substrate. It also isolates the fiber-chip connection from external forces transmitted through the fiber by providing a low-moment fiber stake. A cantilever is formed by pigtailing a V-groove fiber array to an optical waveguide chip using index-matched epoxy. Only the endface of the fiber-array and the sidewall of the waveguide chip are involved in the epoxy-bond. The fiber ribbon is staked away from the cantilever to a pedestal structure, which can comprise silicon and/or glass. The fiber ribbon and the layers of the pedestal are attached together using a low-modulus pedestal epoxy.

### BACKGROUND OF THE INVENTION

Recent developments in integrated optic circuits have enabled the incorporation of relatively high levels of functionality into monolithic planar waveguide chips. Nevertheless, optical fiber is still used to interconnected chips and for transport over distances.

A major challenge associated with the use of planar waveguide chips is, therefore, the connection between optical fibers and waveguides on the chip. The fibers and waveguides have microscopic cores that must be precisely aligned to couple optical signals between the planar waveguides and the fibers with low loss. This challenge is made even more difficult when the planar waveguides are fabricated in high refractive index contrast material systems where the waveguides are much smaller than in more conventional systems and the coupling is consequently more sensitive to misalignment.

The waveguide-optical fiber connection must not only be accurately aligned, but mechanically robust. The alignment must be stable over time, temperature cycling, and shock testing. Many specifications dictate that the coupling cannot change by more than 0.5 dB after temperature cycling or a shock test.

A typical pigtail attach system involves a V-groove fiber array that is aligned and epoxy bonded to a waveguide chip. The V-groove fiber array and the chip are mounted to a common substrate or submount. In some applications, a bridge, made from silicon for example, is further bonded between the top of the chip and the top of the substrate of the V-groove fiber array in an effort to further stabilize the connection between the chip and the facets of the array's fiber pigtails.

### SUMMARY OF THE INVENTION

During epoxy curing and reliability testing, the pigtail attach can develop alignment errors that change and typically reduce the coupling. Most commonly, slight angular shifts can arise during the curing of the epoxy. In addition, different material thermal expansion coefficients shift the fiber from its original alignment as a result of temperature cycling. These effects decrease yield during manufacturing and prevent qualification of the device for commercial deployment.

The invention involves a pigtail attach system that exhibits little degradation or change in the coupling during curing and minimizes the impact of different thermal expansion coefficients between the fiber and the substrate. It also involves the isolation of the fiber-chip connection from external forces transmitted through the fiber by providing a low-moment fiber stake.

The invention can reduce alignment error caused by effects such as thermal expansion coefficient mismatch, and shifts during epoxy curing by attaching the V-groove fiber array to the optical chip in a cantilever fashion. The invention addresses the problem of external force transmission through the fiber ribbon by attaching the fiber to one or more pedestal structures. The invention also addresses the problem of expansion coefficient mismatch by forming the pedestal structures from materials and epoxies that have similar thermal expansion coefficients to the optical chip.

In an exemplary embodiment, a cantilever is formed by pigtailing a V-groove fiber array to an optical waveguide chip using index-matched epoxy. Only the endface of the fiber-array and the sidewall of the waveguide chip are involved in the epoxy-bond. The fiber ribbon is staked away from the cantilever to a pedestal structure, which can comprise silicon and/or glass. The fiber ribbon and the layers of the pedestal are attached together using two epoxies having different moduli. The epoxy used to attach the pedestal to the substrate is the same as the epoxy used to attach the optical waveguide chip to the substrate.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention.

FIG. 1A is a side elevation view of an optical waveguide chip and a V-groove fiber array, and the mechanical attachment between the chip, V-groove array, and a common alumina substrate;

FIG. 1B is a schematic side elevation view showing the epoxy bond between the chip and the V-groove fiber array;

FIG. 1C is schematic side elevation view showing the epoxy bond between the chip and the angled V-groove fiber array;

FIG. 2 is a top plan view showing the configuration of a pedestal structure;

FIG. 3 is a side elevation showing the pedestal structure;

FIG. 4 is a perspective view of an electro-optical device including an optical waveguide chip that is connected to a V-groove fiber array;

FIG. 5 is a side plan view showing a configuration of two pedestal structures;

FIG. 6 is a top plan view showing a configuration of four pedestal structures;

FIG. 7 is a top plan view showing the configuration of a cap layer of the pedestal structure with an epoxy layer comprising multiple epoxies; and

FIG. 8 shows a side plan view showing multiple cantilever attach systems on a waveguide chip.

### DETAILED DESCRIPTION OF THE INVENTION

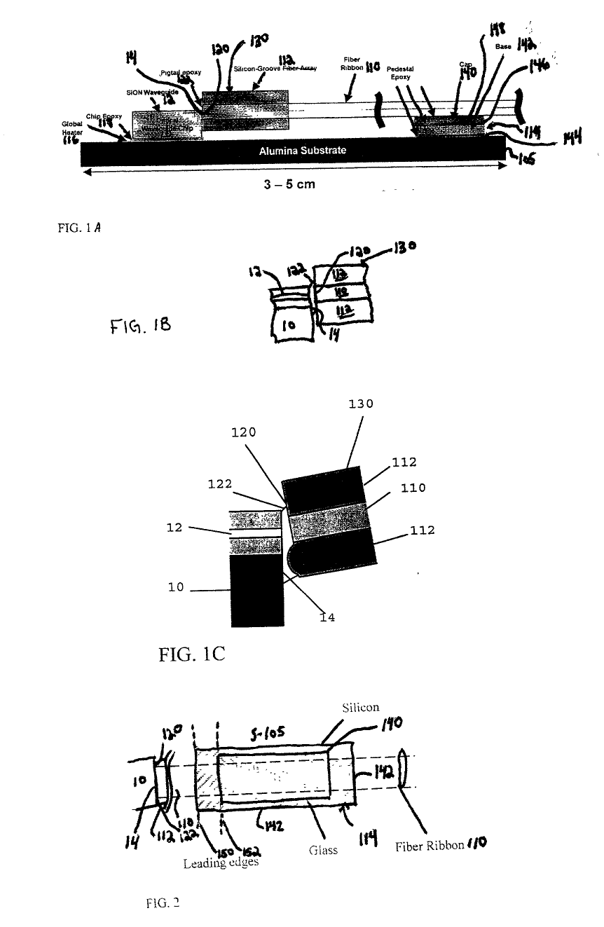

FIG. 1A shows a V-groove fiber array 130 including a fiber ribbon 110 in a silicon V-groove substrate 112 that is pigtailed to an optical waveguide chip 10 and staked to a pedestal structure 114, in accordance with the invention.

In the illustrated embodiment, the optical waveguide chip 10 is fabricated from silicon wafer material. It contains SiON planar waveguides 12. This is a high refractive index contrast system in which the waveguide cores can be less than 4-5 micrometers (μm) across and are typically less than 2 μm in both the transverse and lateral directions.

The optical waveguide chip 10 is epoxy bonded to an alumina substrate 105. Presently, an intervening global heater 116 is provided to control the temperature of the chip 10. This is preferably a resistive heating unit. This forms a hybrid of chip 10 and substrate 105 with the intervening layers of the chip epoxy 118 and the heater 116.

The waveguide chip 10 is placed over the global heater 116, which is used to maintain a nominal operating temperature for the chip 10. A thick film layer of a resistive material, such as polysilicon, is formed on the alumina substrate 105 to produce the global heater 116. In this embodiment, a 6 ohm heater is used and the optical chip 10 is maintained at an operating temperature of 70° C.

The end length of the fiber ribbon 110 is stripped of its outer jacket and placed into the silicon V-groove substrate 112 to form a V-groove fiber array 130. The fiber pigtails of the ribbon 110 are then coupled to the waveguides 12 of the chip 10 by attaching the facets 120 and the V-groove substrate 112 to the chip 10 in a cantilever fashion using an epoxy layer 122. An index matched epoxy is preferably used to reduce coupling loss due to reflection.

FIG. 1B shows the details of the connection between the V-groove fiber array 130 and the chip 10. A thin layer of pigtail epoxy 122 is used. Specifically, the distance between the sidewall 14 of the chip 10 and the endface 120 the V-groove fiber array is filled with the epoxy 122 and is less than about 3 μm. It is preferably less than 2 μm thick, and in an exemplary embodiment is about 1 μm.

Imperfections in the fiber or V-groove substrate, such as rounding of the fiber ends or rounding of the V-groove face, can also increase the separation between the V-groove fiber array 130 and the waveguide chip 10, as shown in FIG. 1C. The V-groove fiber array end-face 120 can be slightly angled when it is attached so that the coupling between the fiber cores 110 and the waveguides 12 is maximized.

During construction, the pigtail epoxy 122 is applied to the endface 120 of the V-groove fiber array 130, which is then attached to the sidewall 14 of the waveguide chip 10. The epoxy is applied so that only these two surfaces, which are in direct opposition, are epoxy-bonded. Once the cores of the fiber pigtails of the ribbon 110 are aligned with the SiON waveguides 12 to maximize the coupling efficiency between the fibers and the waveguides, the epoxy 122 is cured. In this embodiment, the V-groove fiber array 130 can be slightly tilted in the vertical direction so that the ribbon 110 and the waveguides 12 are in closest proximity and the optical coupling between the V-groove array 130 and the waveguide chip 10 is maximized.

The application of the pigtail epoxy 122 is such that epoxy is in a thin layer and only present on the endfaces of the V-groove array 130 and the sidewall 14 of the chip 10 minimizes shifts in coupling efficiency during the epoxy cure. The index-matched pigtail epoxy 122 used in this embodiment typically shrinks by 0.5% during curing. Using a 1 μm thick layer of epoxy, a contraction of 0.5% results in only 5 nanometers (nm) of shift, which is typically acceptable. In the present embodiment, the waveguides are ˜1.3 μm in size and the fiber cores are ˜8 μm in size and can tolerate this small shift.

Moreover, because only the V-groove fiber array endface 120 and the chip sidewall 14 are epoxy-coated, shrinkage primarily occurs in the horizontal plane, perpendicular to the fiber array endface. Thus, the curing process does not cause any angular shifts between the chip 10 and the V-groove array 130 as typically occurs with configurations using silicon bridges because of stress asymmetries. Further, changes in temperature and humidity, which may impact the material stress of the epoxy, will have little impact on the coupling since it will not induce angular changes.

The cantilever structure 114 mechanically isolates the distal side of fiber ribbon 110 from the waveguide chip 10. The cantilever's design prevents the thermal expansion and contraction of the substrate 105 from affecting the alignment of the V-groove fiber array 130 with the SiON waveguides 12.

The pedestal structure 114 is used to minimize the external forces acting on the fiber ribbon 110 and the cantilever attach, such as pulling during handling of the fiber ribbon and package. The fiber ribbon 110 is staked to the alumina substrate 105 through the pedestal 114.

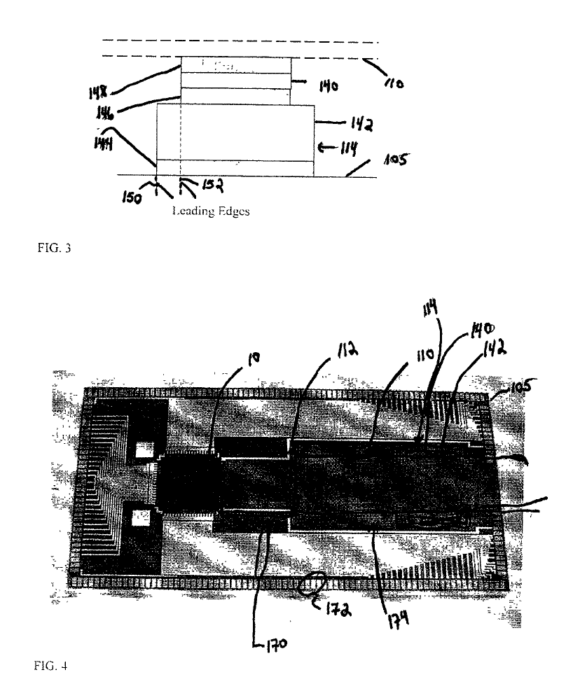

FIGS. 2 and 3 are top and side views showing the construction of the pedestal structure 114 in more detail.

The pedestal structure 114 currently comprises a cap layer 140 of glass, which is attached to a base 142 of silicon, which is further attached to the alumina substrate 105. These layers have a low thermal expansion coefficient, that is similar to the optical chip, and are attached using pedestal epoxies. Specifically a base-substrate epoxy layer 144 bonds the base 142 to the substrate 105; a base-cap epoxy layer 146 bonds the cap 140 to the base 142; and a cap-ribbon epoxy layer 148 bonds the fiber ribbon 110 to the cap 140. The pedestal preferably has the same thermal expansion coefficient as the optical chip so that thermally induced variations are closely matched.

The design of the pedestal structure 114 also compensates for the different thermal expansion coefficients between the fiber ribbon 110 and the substrate 105. The pedestal 114 is somewhat flexible to limit the stress on the fiber ribbon 110 between the chip 10 and the pedestal structure 114 that is induced with temperature cycling. In operation, the pedestal structure 114 flexes slightly to limit the stress induced by the difference in thermal expansion coefficients between the ribbon 10 and the substrate 105. As a result, the stress does not become so great that the pigtail epoxy 122 fails.

In contrast, the pedestal structure 114 must not be too flexible. The pedestal also functions to provide stress relief from external pulling on the fiber ribbon 110. If the pedestal epoxies are too elastic, external forces on the fiber can translate through the pedestal to the cantilever.

The force-displacement performance of the pedestal epoxies preferably have a large linear region, so that the epoxies are capable of withstanding large external forces on the fiber ribbon 110 without permanently deforming. The yield strength of the epoxies must be greater than the forces typically encountered during physical handling of the fiber ribbon and the fiber package, such as pulling and twisting, so that industry specifications are met and so that the fiber package has the durability required for commercial applications.

Further, the pedestal epoxies must not be too rigid such that the pedestal cannot flex slightly to limit forces produced by thermal cycling. To this end, the pedestal epoxies 144, 146, 148 preferably have a lower modulus than the pigtail epoxy 122.

The pedestal structure is aligned with the waveguide chip 10 and the V-groove substrate 112 so that the leading edges 150, 152 of the base 142 and the cap 140 are parallel to the sidewall 14 of the chip 10 and the endface 120 V-groove array 130.

The pedestal epoxy including the base-substrate epoxy 144 and the cap-base epoxy 146 are uniformly applied using print screening in the current implementation. The epoxy coat is symmetric about the center line of the fiber ribbon 110 and the V-groove array substrate 112.

The uniform/symmetric pedestal epoxy in combination parallelism between the leading edges 152, 150 of the cap 140 and base 142 relative to the sidewall 14 of the chip 10 prevent any torque or shear forces on the pigtail epoxy 122. Instead, any forces arising due to thermal expansion coefficient mismatch result in a single force vector that is orthogonal to the sidewall 14. This further prevents failure of the pigtail epoxy 122.

All of the layers of the pedestal epoxy are attached using the low-modulus epoxy. The fiber ribbon 110 is also attached to the cap 140 by the low-modulus epoxy 148. The pedestal epoxy preferably has a percent elasticity where

% elasticity=displacement/length,

In any event, the pedestal epoxy 144, 146, 148 has a higher elasticity than the pigtail epoxy 122 used to bond the fiber pigtails to the waveguide chip 10.

The moduli of most epoxies, including the low-modulus epoxy used in this embodiment, experience a transition at 100° C. and are directly related to temperature. As the temperature increases, the epoxy becomes softer and as the temperature decreases, the epoxy becomes more rigid. Because the low modulus epoxy in this embodiment is used at an operating temperature of 70° C., the pedestal epoxy is selected so that it functions over a wide temperature range while maintaining an acceptable elasticity during operation and during handling.

The pedestal dimensions provide the desired amount of epoxy thickness and support for the fiber ribbon 110, so that the pedestal structure 114 has the desired strength and elasticity. Preferably two or three layers of pedestal epoxy are used to provide enough elasticity to absorb the external forces on the fiber ribbon 110 without translating them through to the pigtail epoxy layer 122.

To change the mechanical properties of the pedestal structure 114 while maintaining the height of the pedestal, the thickness of the layers can be adjusted to accommodate the desired epoxy thickness. For example, if the thickness of the epoxy layers increases or the number of epoxy layers increases, the thickness of the base and cap layers must be decreased. Generally, the pedestal 114 must support the fiber ribbon 110 at the same height as the cantilever attach so that the cantilever does not experience any significant vertical shear forces.

FIG. 4 shows one implementation of the electro-optical device incorporating the waveguide chip 10. Conductive traces 170 connect the chip 10 to wire bond pads 172 at the periphery of the substrate 105. A free area 174, however, is provided over which the fiber ribbon 110 is routed between the pedestal 114 and the chip 10.

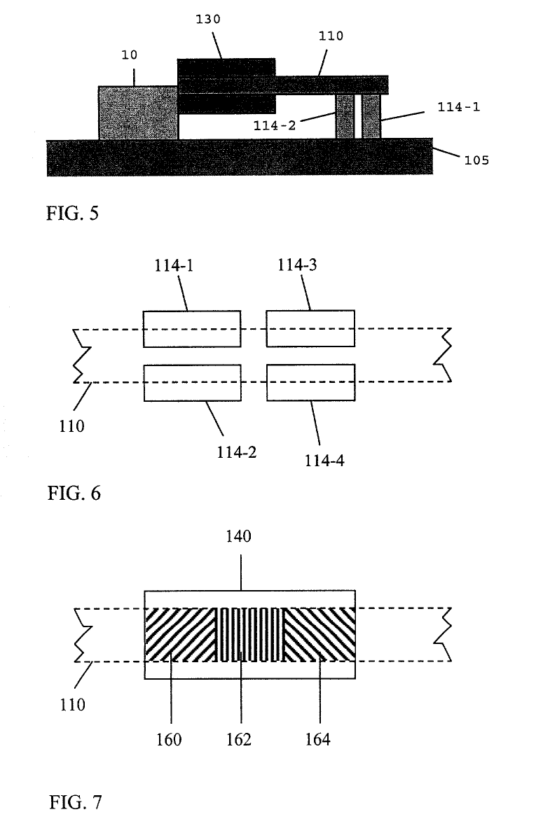

In another exemplary embodiment, a pigtail attach system utilizes a cantilever attach and multiple pedestals to stake the fiber ribbon to the substrate. Each pedestal preferably has the same thermal coefficient expansion. Each pedestal preferably has a different stiffness so that the stiffness increases as the distance to the optical chip decreases. Pedestals 114-1, 1142, 114-3, 114-4 can be arranged in a variety of configurations, such as longitudinally and laterally, as shown in FIG. 5 and FIG. 6.

In another exemplary embodiment, a pigtail attach system utilizes a cantilever attach and a pedestal with layers having multiple epoxies in each layer. Each layer of epoxy in the pedestal can be formed from multiple epoxies having the same thermal expansion coefficients and different moduli. For example, three epoxies 160, 162, 164 can be longitudinally arranged on a cap layer 140 of the pedestal, as shown in FIG. 7. The epoxies are arranged so that the first epoxy 164 has the highest modulus and the third epoxy 160 has the lowest modulus. Any number of epoxies can be arranged in any desired configuration, such as laterally and longitudinally.

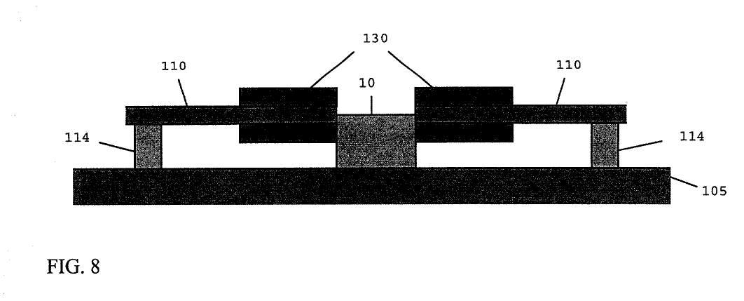

In another exemplary embodiment, multiple pigtailed attach systems, each utilizing a cantilever attach and a pedestal, are configured for multiple end-faces of a waveguide chip. For example, as shown in FIG. 8, a first pigtail attach system can be configured on one side of a waveguide chip 10, as described in the previous embodiments, and a second pigtail attach system can be configured on the opposite side of the waveguide chip 10, also as described in the previous embodiments. The first pigtail attach system can be used as an input and the second pigtail attach system can be used as the output. Each pigtail attach system can also be used for both input and output.

Although the present invention has been shown and described with respect to several preferred embodiments thereof, various changes, omissions and additions to the form and detail thereof, may be made therein, without departing from the spirit and scope of the invention.

What is claimed is:

1. An attach system between a fiber pigtail array and a planar waveguide chip, the system comprising:
a fiber array substrate to which the fiber pigtail array is secured; and
an epoxy bond between the fiber pigtail array and the waveguide chip, wherein an epoxy of the epoxy bond is only applied to a sidewall of the waveguide chip and an endface of the fiber pigtail array.

2. An attach system as claimed in claim 1, wherein a gap between endfaces of the fiber pigtails and the sidewall of the waveguide chip is less than 4 μm.

3. An attach system as claimed in claim 1, wherein a gap between endfaces of the fiber pigtails and the sidewall of the waveguide chip is less than 2 μm.

4. An attach system as claimed in claim 1, wherein the fiber array substrate extends from the waveguide chip in the fashion of a cantilever.

5. An attach system as claimed in claim 1, further comprising at least one pedestal on a side of the fiber array substrate remote from the waveguide chip, the pedestal extending between the fiber pigtail array and a system substrate, to which the waveguide chip is attached.

6. An attach system as claimed in claim 5, wherein the pedestal is epoxy bonded to the fiber pigtail array and the system substrate.

7. An attach system as claimed in claim 5, wherein an epoxy used to bond the fiber pigtail array to the pedestal and/or the pedestal to the system substrate has a higher elasticity than an epoxy used to bond the fiber pigtails to the waveguide chip.

8. An attach system as claimed in claim 5, wherein an epoxy used to bond the fiber pigtail array to the pedestal and/or the pedestal to the system substrate has an elasticity that is greater than 20 mPa.

9. An attach system as claimed in claim 5, wherein a leading edge of the pedestal is parallel to the sidewall of the waveguide chip.

10. An attach system as claimed in claim 5, wherein an epoxy used to connect the pedestal to the system substrate extends to a proximal edge of the pedestal.

11. An attach system as claimed in claim 5, wherein the pedestal comprises a base and a cap, the base and the cap being bonded to each other, the base being further bonded to the system substrate and the cap being further bonded to the fiber pigtail array.

12. A system for attaching a fiber pigtail array to a planar waveguide chip, the system comprising:
a system substrate to which the waveguide chip is attached;
a fiber array substrate to which the fiber pigtail array is secured, the fiber array substrate being bonded to the waveguide chip and extending from the waveguide chip in the fashion of a cantilever; and
at least one pedestal on a side of the fiber array substrate remote from the waveguide chip, the pedestal extending between the fiber pigtail array and the system substrate.

13. A system as claimed in claim 12, wherein a gap between endfaces of the fiber pigtails and the sidewall of the waveguide chip is less than 4 μm.

14. A system as claimed in claim 12, wherein a gap between endfaces of the fiber pigtails and the sidewall of the waveguide chip is less than 2 μm.

15. A system as claimed in claim 12, wherein the pedestal is epoxy bonded to the fiber pigtail array and the system substrate.

16. A system as claimed in claim 12, wherein an epoxy used to bond the fiber pigtail array to the pedestal and/or the pedestal to the system substrate has a higher elasticity than an epoxy used to bond the fiber pigtails to the waveguide chip.

17. A system as claimed in claim 12, wherein an epoxy used to bond the fiber pigtail array to the pedestal and/or the pedestal to the system substrate has an elasticity that is greater than 20 mPa.

18. A system as claimed in claim 12, wherein a leading edge of the pedestal is parallel to the sidewall of the waveguide chip.

19. A system as claimed in claim 12, wherein an epoxy used to connect the pedestal to the system substrate extends to a proximal edge of the pedestal.

20. A system as claimed in claim 12, wherein the pedestal comprises a base and a cap, the base and the cap being bonded to each other, the base being further bonded to the system substrate and the cap being further bonded to the fiber pigtail array.

21. A method for attaching a fiber pigtail array to a planar waveguide chip, the method comprising:
attaching the planar waveguide chip to a system substrate;
aligning and bonding a fiber array substrate, which holds the fiber pigtail array, to a sidewall of a waveguide chip; and
securing the fiber pigtail array to at least one pedestal on a side of the fiber array substrate that is remote from the waveguide chip, the pedestal extending between the fiber pigtail array and the system substrate.

22. A method as claimed in claim 21, wherein the fiber array substrate is not attached to the system substrate.

23. A method as claimed in claim 21, wherein the step of bonding the fiber array substrate to the sidewall of the waveguide chip comprises closing a gap between endfaces of fiber pigtails of the fiber pigtail array and the sidewall of the waveguide chip to less than 4 μm.

24. A method as claimed in claim 21, wherein the step of bonding the fiber array substrate to the sidewall of the waveguide chip comprises closing a gap between endfaces of fiber pigtails of the fiber pigtail array and the sidewall of the waveguide chip to less than 2 μm.

25. A method as claimed in claim 21, wherein an epoxy used to bond the fiber pigtail array to the pedestal and/or the pedestal to the system substrate has a higher elasticity than an epoxy used to bond the fiber pigtails to the waveguide chip.

26. A method as claimed in claim 21 further comprising screen printing an epoxy to the pedestal.

27. A method as claimed in claim 21 further comprising aligning a proximal edge of the pedestal to be parallel to the sidewall of the waveguide chip.
